(19) United States
(12) Patent Application Publication
(10) Pub. No.: US 2012/0013715 A1
(43) Pub. Date: Jan. 19, 2012

(54) STEREOSCOPIC IMAGING DEVICE

(75) Inventor: SHIH-CHIEH YEN, Tu-Cheng (TW)

(73) Assignee: HON HAI PRECISION INDUSTRY CO., LTD., Tu-Cheng (TW)

(21) Appl. No.: 12/894,094

(22) Filed: Sep. 29, 2010

(30) Foreign Application Priority Data
Jul. 16, 2010 (TW) 99123375

(51) Int. Cl. H04N 13/02

(52) U.S. Cl. 348/49; 348/E13.074

(57) ABSTRACT

A stereoscopic imaging device includes two lens modules, two light guiding tubes, a reflection element, a motor, an image sensor, and a controller. Each light guiding tube includes a light incident end connected to a corresponding lens module and a light emitting end. The two light emitting ends of the light guiding tubes face to each other. The reflection element is positioned between the two light emitting ends. The image sensor faces the reflection element. The motor is connected to the reflection element. The controller is electrically connected to the image sensor and the motor. The controller is used for controlling the motor to drive the reflection element to rotate, thus to make the reflection element reflect the light from the two first guiding tubes to the image sensor in turn.

### BACKGROUND

1. Technical Field

The present disclosure relates to stereoscopic or three-dimensional imaging technologies and particularly, to a stereoscopic imaging device.

2. Description of Related Art

A typical stereoscopic image capture device utilizes a pair of separate imaging systems. Each imaging system has an image sensor to capture an image of an object from a different perspective. The resulting captured images, called left and right image pairs, may be viewed in tandem to create the effect of three-dimensional viewing. Alternatively, the image pairs can be computer-combined to create a three-dimensional representation of the imaged scene. However, two image sensors are utilized to provide such systems. This results in high cost of the system for three-dimensional applications.

What is needed, therefore, is a stereoscopic imaging device to overcome the above-described problem.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments.

FIG. 1 is a schematic view of a stereoscopic imaging device according to an exemplary embodiment.

FIG. 2 is an exploded view of the stereoscopic imaging device of FIG. 1.

FIG. 3 is similar to FIG. 2, but showing the stereoscopic imaging device inverted.

### DETAILED DESCRIPTION

Embodiments of the present disclosure will now be described in detail below, with reference to the accompanying drawings.

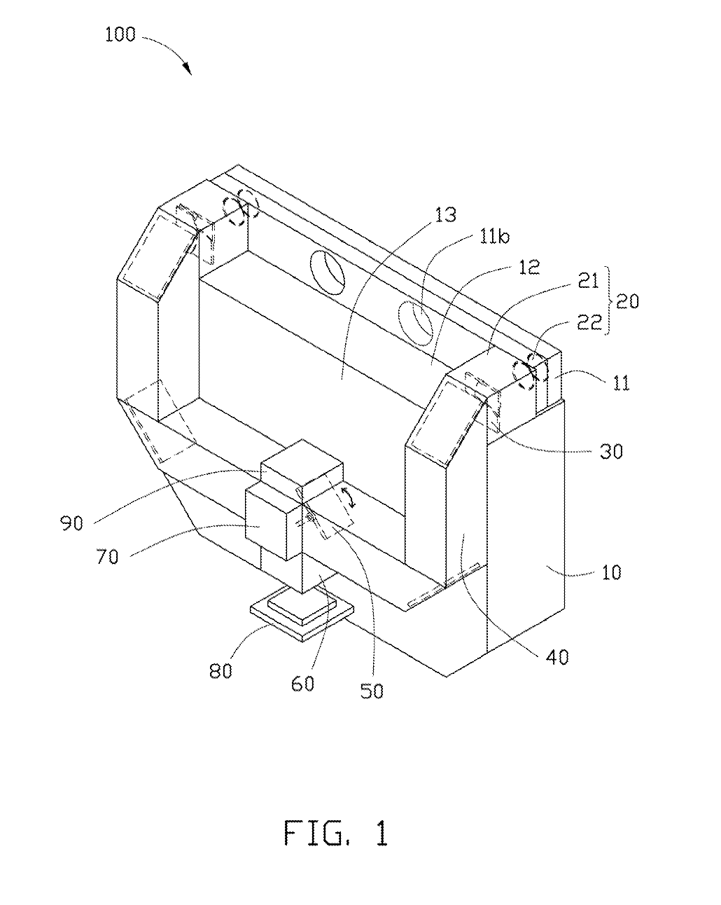

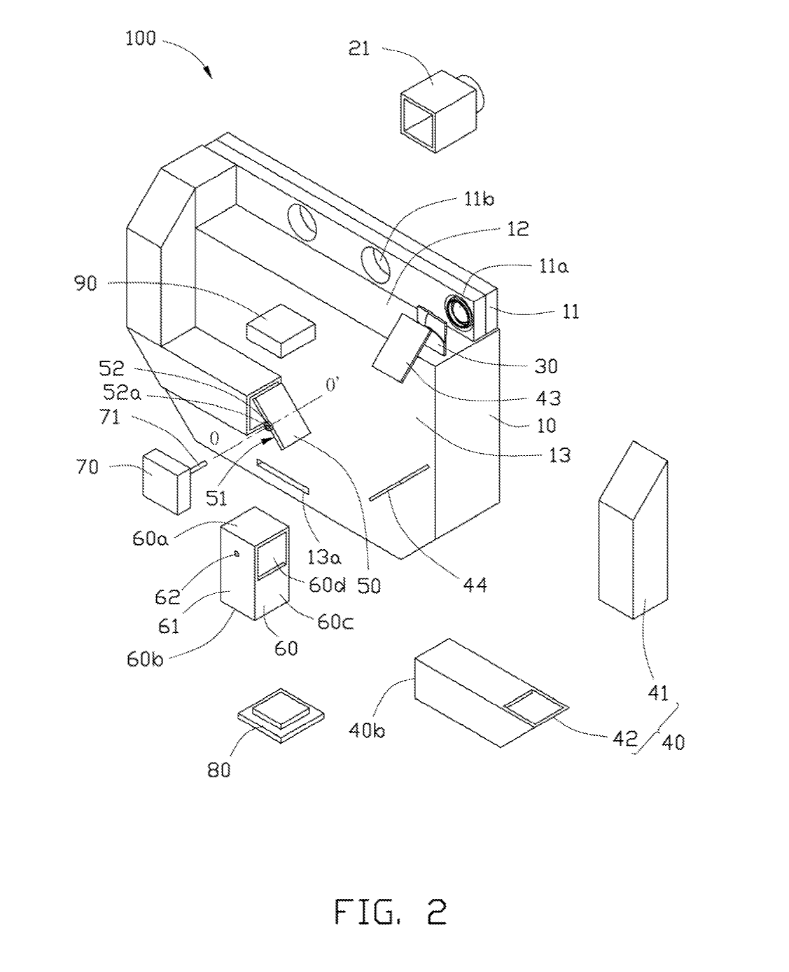

Referring to FIGS. 1-2, a stereoscopic imaging device 100, according to an exemplary embodiment is shown. The stereoscopic imaging device 100 includes a base 10, a flat plate 11, two lens modules 20, two shutters 30, two first light guiding tubes 40, a reflection element 50, a second light guiding tube 60, a motor 70, an image sensor 80, and a controller 90.

The base 10 includes a top surface 12 and two side surfaces 13 adjacent to the top surface 12. The side surface 13 defines a groove 13a to fix the image sensor 80 in place. The flat plate 11 is fixed on the top surface 12. In the present embodiment, the flat plate 11 is rectangular. The flat plate 11 defines two first holes 11a at two opposite ends and a second hole 11b between the two first holes 11a. The first hole 11a is used for partially receiving the lens module 20. The second hole 11b is used for receiving a flash lamp (not shown). In other embodiments, the flat plate 11 can also be integrally formed with the base 10.

The two lens modules 20 are fixed on the top surface 12 of the base 10, and are coaxial with the corresponding first holes 11a. In the present embodiment, the lens module 20 includes a connecting tube 21 and a group of lenses 22 received in the connecting tube 21. The group of lenses 22 includes three lenses. The connecting tube 21 defines a stepped hole (not labeled) having a single step resulting in a portion with large diameter and a portion with a smaller diameter. The group of lenses 22 is received in the smaller portion of the stepped hole. The shutter 30 is received in the larger portion of the stepped hole.

The shutter 30 can be a mechanical shutter or an electronic shutter. In the present embodiment, the shutter 30 is an electronic shutter. The shutter 30 is positioned behind the group of lenses 22. In other embodiments, the shutter 30 can be positioned between lenses of the group of lenses 22.

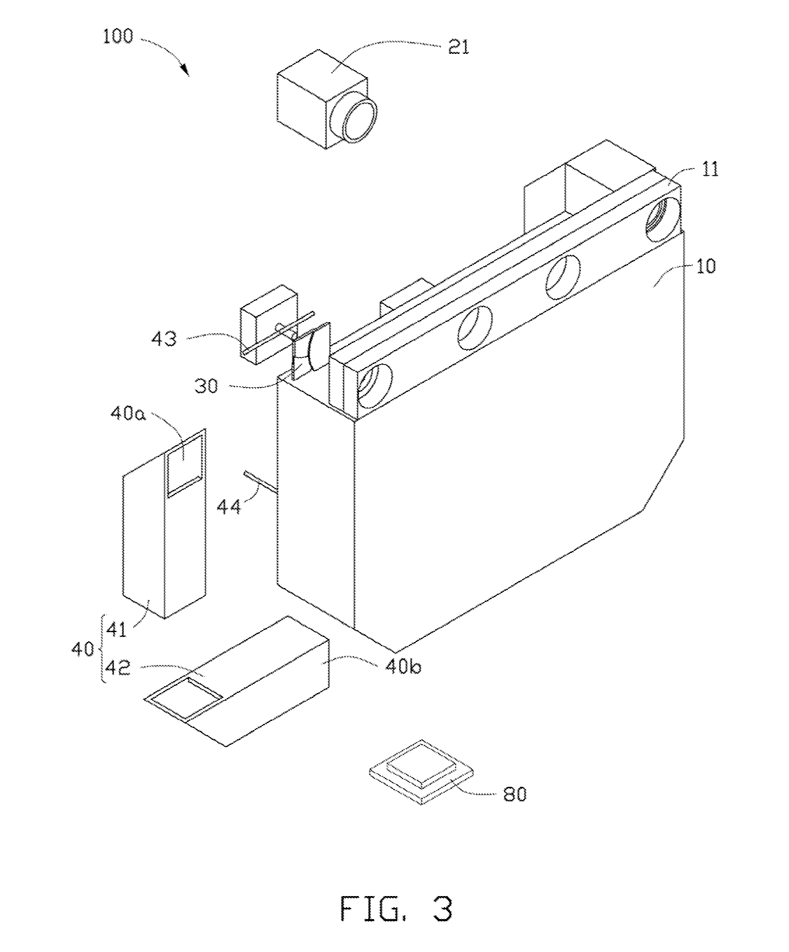

Referring to FIGS. 2-3, each first light guiding tube 40 has an L-shaped configuration and is glued on the side surface 13 of the base 10. The first light guiding tube 40 includes a light incident end 40a and a light emitting end 40b. In the present embodiment, the first light guiding tube 40 includes a vertical light guiding tube 41 and a horizontal light guiding tube 42. The light incident end 40a is an end of the vertical light guiding tube 41. The light incident end 40a is optically sealed and glued to the connecting tube 21. The other end of the vertical light guiding tube 41 is optically sealed and glued to an end of the horizontal light guiding tube 42 by glue. The other end of the horizontal light guiding tube 42 is the light emitting end 40b. The light emitting end 40b is optically sealed and glued to the second light guiding tube 60. A first reflector 43 is received in the vertical light guiding tube 41 adjacent to the light incident end 40a. The first reflector 43 is used for reflecting the light entering through the shutter 30 into the vertical light guiding tube 41. A second reflector 44 is received in the horizontal light guiding tube 42 adjacent to the end of the horizontal light guiding tube 42 abutting the vertical light guiding tube 41. The second reflector 44 is used for reflecting the light from the vertical light guiding tube 41 into the horizontal light guiding tube 42 to the reflection element 50. In other embodiments, the first light guiding tube 40 can be an optical fiber bundle, and the first reflector 43 and the second reflector 44 omitted.

The reflection element 50 is positioned between the light emitting ends 40b of the two first light guiding tubes 40. The reflection element 50 is used for reflecting the light from the two first light guiding tubes 40 to the image sensor 80. The reflection element 50 is selected from one of a flat mirror and a reflection prism. In the present embodiment, the reflection element 50 is a flat mirror with a front surface silvered. In other embodiments, the reflection element 50 can be a total reflection prism. The reflection element 50 includes a reflection surface 51 and a connection portion 52. In order to prevent eccentricity of the reflection element 50, the connection portion 52 is fixed on the side surface (not labeled) adjacent to the reflection surface 51, and coaxial with the central axis OO′ of the reflection element 50. The connection portion 52 defines a shaft hole 52a to receive a rotor 71 of the motor 70 therein.

In the present embodiment, the reflection element 50 is received in the second light guiding tube 60. The second light guiding tube 60 is substantially perpendicular to the horizontal light guiding tubes 42. The second light guiding tube 60 is optically sealed and connected to the horizontal light guiding tubes 42. In the present embodiment, a top end 60a of the second light guiding tube 60 is sealed, and a base end 60b of the second light guiding tube 60 is open. The base end 60b faces the image sensor 80. Two opposite side surfaces 60c of the second light guiding tube 60 define two holes 60d respectively communicated with the horizontal light guiding tubes 42. A front surface 61 of the second light guiding tube 60 defines a round hole 62. The reflection element 50 reflects the light from the first light guiding tube 40 through the second light guiding tube 60 to emit out from the base end 60b.

In the present embodiment, the motor 70 is a stepper motor. The motor 70 is connected to the reflection element 50 to drive the reflection element 50 to rotate. The motor 70 is electrically connected to the controller 90. The motor 70 is fixed on the front surface 61 of the second light guiding tube 60. The rotor 71 extends through the round hole 62 of the second light guiding tube 60 and is fixed in the shaft hole 52a of the connection portion 52.

The image sensor 80 is configured for converting an optical image to an electrical signal. One edge of the image sensor 80 is inserted in the groove 13a. The image sensor 80 faces the second light guiding tube 60 for receiving the light emitted from the second light guiding tube 60. In the present embodiment, the image sensor 80 faces the base end 60b of the second light guiding tube 60, and receives the light emitted from the base end 60b. The image sensor 80 can be a CCD (Charge Coupled Device) or a CMOS(Complementary Metal Oxide Semiconductor).

The controller 90 is an Application Specific Integrated Circuit (ASIC) chip. The controller 90 is glued on the top end 60a of the second light guiding tube 42. The controller 90 is electrically connected to the two shutters 30, the motor 70, and the image sensor 80. The controller 90 stores a controlling program. When the stereoscopic imaging device 100 captures an image, the controller 90 is used for controlling the motor 70 to rotate the reflection element 50, thus to make the reflection surface 51 of the reflection element 50 to face the two light emitting ends 40b of the two horizontal light guiding tubes 42 in turn. The reflection surfaces 51 reflect the light from the two first guiding tubes 40 to the image sensor 80 in turn. The left and right images are successively captured by the image sensor 80 to form a left and right image pair. The controller 90 also controls the two shutters 30 to operate in turn corresponding to the rotation direction of the reflection element 50. The image sensor 80 transfers the successive images to the controller 90. The controller 90 is connected to a display (not shown). The controller 90 controls the display to display the successive images in the same order. As a result, a single image sensor 80 is utilized to reduce costs of the stereoscopic imaging device 100.

While certain embodiments have been described and exemplified above, various other embodiments will be apparent to those skilled in the art from the foregoing disclosure. The present disclosure is not limited to the particular embodiments described and exemplified, and the embodiments are capable of considerable variation and modification without departure from the scope of the appended claims.

What is claimed is:

1. A stereoscopic imaging device comprising:
two lens modules;
two first light guiding tubes, each first light guiding tube comprising:
a light incident end connected to a corresponding lens module for receiving the light from the lens module; and
a light emitting end for emitting a light from the light incident end, wherein the two light emitting ends of the two first light guiding tubes are faced to each other;
a reflection element positioned between the two light emitting ends;
an image sensor facing to the reflection element;
a motor connected to the reflection element; and
a controller electrically connected to the image sensor and the motor, and configured for controlling the motor to drive the reflection element to rotate such that the reflection element is capable of reflecting the light from the two first light guiding tubes to the image sensor in turn.

2. The stereoscopic imaging device as claimed in claim 1, further comprising a second light guiding tube communicated to the two light emitting ends, the second light guiding tube receiving the reflection element, and defining an open end facing the image sensor.

3. The stereoscopic imaging device as claimed in claim 1, comprising a base, the base comprising a top surface and a side surface adjacent to the top surface, the two lens modules positioned on the top surface, the first light guiding tube, the second light guiding tube, and the image sensor positioned on the side surface, the controller and the motor positioned on an outer surface of the second light guiding tube.

4. The stereoscopic imaging device as claimed in claim 1, wherein the motor is a stepper motor.

5. The stereoscopic imaging device as claimed in claim 1, comprising two shutters, the two shutters received in the two lens modules respectively, the two shutters electrically connected to the controller, and the controller configured to control the two shutters to operate in turn corresponding to the rotation of the reflection element.

6. The stereoscopic imaging device as claimed in claim 1, wherein each first light guiding tube comprises a vertical light guiding tube and a horizontal light guiding tube perpendicular to the vertical light guiding tube, a first reflector is positioned at one end of the vertical light guiding tube abutting the lens module, the first reflector is configured for reflecting the light to the horizontal light guiding tube, a second reflector is received in the connection between the horizontal light guiding tube and the vertical light guiding tube, the second reflector is configured for reflecting the light from the vertical light guiding tube to the image sensor.

7. The stereoscopic imaging device as claimed in claim 6, wherein the reflection element is positioned between the two horizontal light guiding tubes.

8. The stereoscopic imaging device as claimed in claim 6, further comprising a second light guiding tube communicating to the two horizontal light guiding tubes, the second light guiding tube receiving the reflection element, and defining an open end facing to the image sensor.

9. The stereoscopic imaging device as claimed in claim 1, wherein the reflection element is a flat mirror.

10. The stereoscopic imaging device as claimed in claim 1, wherein the reflection element is a flat mirror with a front surface silvered.

11. The stereoscopic imaging device as claimed in claim 1, wherein the reflection element a reflection prism.

12. The stereoscopic imaging device as claimed in claim 11, wherein the reflection element is a total reflection prism.

13. The stereoscopic imaging device as claimed in claim 1, wherein the first light guiding tube is an optical fiber bundle.
